(19) United States
(12) Patent Application Publication
(10) Pub. No.: US 2023/0046105 A1
(43) Pub. Date: Feb. 16, 2023

(54) Electronic Guest Book Assembly

(71) Applicants: Jephthat Mc Daniel, Lombard, IL (US); Ishmael Mc Daniel, Lombard, IL (US)

(72) Inventors: Jephthat Mc Daniel, Lombard, IL (US); Ishmael Mc Daniel, Lombard, IL (US)

(21) Appl. No.: 17/400,211

(22) Filed: Aug. 12, 2021

(51) Int. Cl. G06Q 10/02; G06K 7/14

(52) U.S. Cl. CPC G06Q 10/02; G06K 7/1417

(57) ABSTRACT

An electronic guest book assembly for tracking attendees of an event includes a host electronic device, such as a tablet computer. Host programming code positioned on a computer processor of the host electronic device enables a display of the host electronic device to present to a host a list of attendees of an event, such as a funeral. The host programming code also enables the host electronic device to store the list of attendees on an internal storage unit of the host electronic device. Attendee programming code, which is selectively positionable on a microprocessor of an attendee electronic device, such as a smart phone, enables the attendee electronic device to receive and to selectively display information and images related to the event. The attendee programming code also enables the attendee electronic device to signal the host electronic device of an arrival of an attendee associated with the attendee electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to guest book assemblies and more particularly pertains to a new guest book assembly for tracking attendees of an event. The present invention discloses a guest book assembly comprising a host electronic device in wireless communication with a plurality of attendee electronic devices, to which programming code is installed. The programming code enables a respective attendee electronic device to communicate attendance of an associated attendee to the host electronic device, which generates a list of attendees for an event. Information and images related to the event are communicated to the plurality of attendee electronic devices.

### (2) Description of Related Art Including Information Disclosed Under 37 CFR 1.97 and 1.98

The prior art relates to guest book assemblies, and in particular electronic guest book assemblies. Prior art electronic guest book assemblies may comprise devices for collecting personal information from attendees for follow-up communications or posting to social network sites. What is lacking in the prior art is a guest book assembly comprising a host electronic device to which attendance is sent from a plurality of attendee electronic devices. Programming code on a respective attendee electronic device allows information and images related to the event to communicated to the respective attendee electronic device.

### BRIEF SUMMARY OF THE INVENTION

An embodiment of the disclosure meets the needs presented above by generally comprising a host electronic device, such as a tablet computer. Host programming code positioned on a computer processor of the host electronic device enables a display of the host electronic device to present to a host a list of attendees of an event, such as a funeral, memorial service, wedding, and the like. The host programming code also enables the host electronic device to store the list of attendees on an internal storage unit of the host electronic device. Attendee programming code, which is selectively positionable on a microprocessor of an attendee electronic device, such as a smart phone, enables the attendee electronic device to receive and to selectively display information and images related to the event. The attendee programming code also enables the attendee electronic device to signal the host electronic device of an arrival of an attendee associated with the attendee electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an electronic guest book assembly according to an embodiment of the disclosure.

FIG. 2 is a front view of an embodiment of the disclosure.

FIG. 3 is a front view of an embodiment of the disclosure.

FIG. 4 is a front view of an embodiment of the disclosure.

FIG. 5 is a block diagram view of an embodiment of the disclosure.

### DETAILED DESCRIPTION OF THE INVENTION

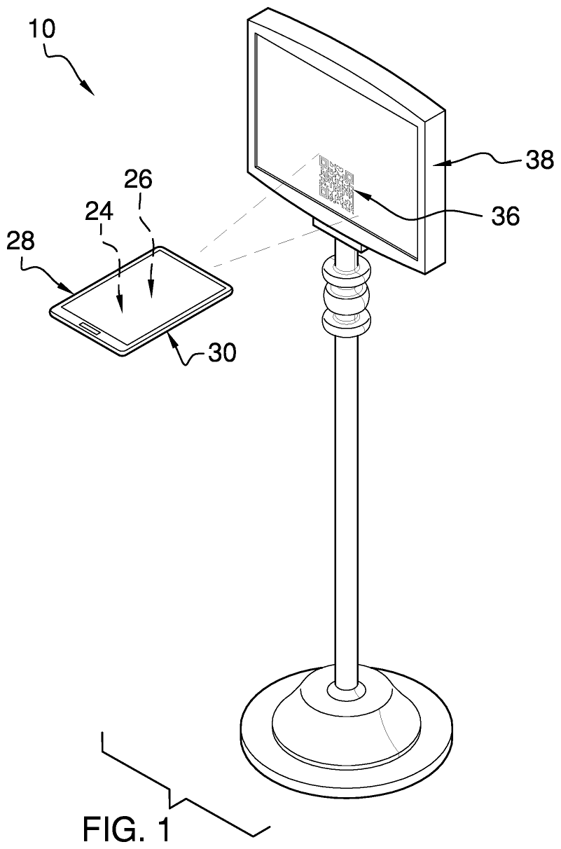

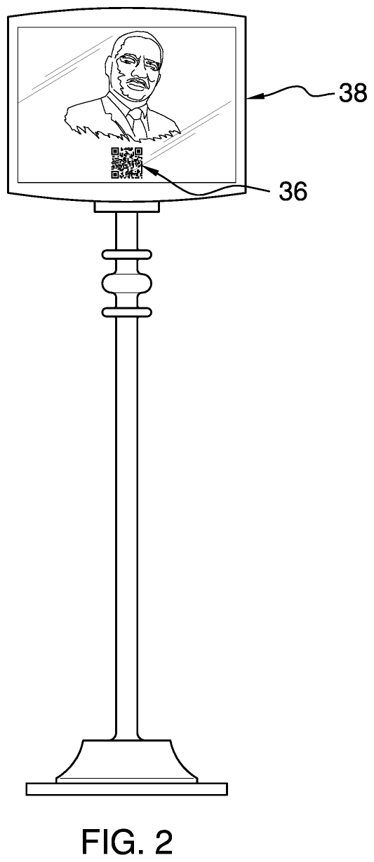

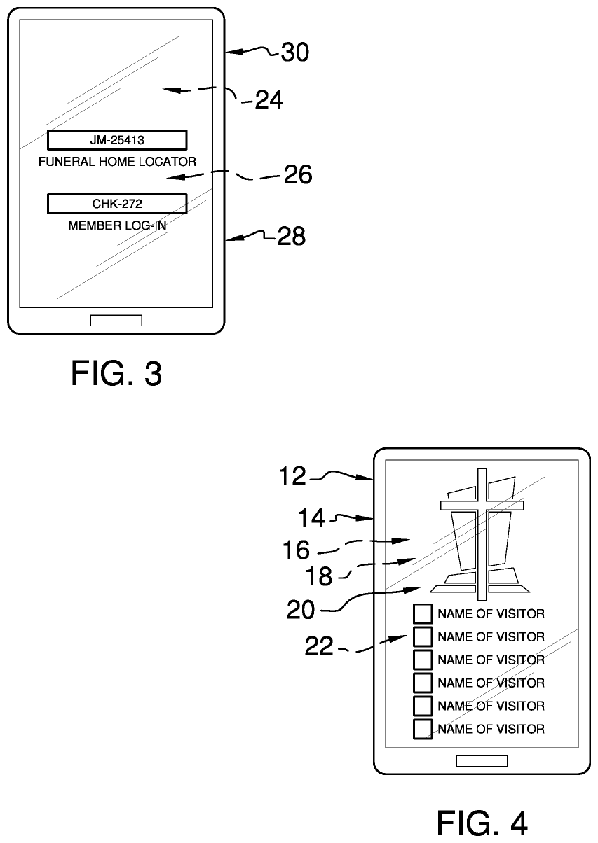

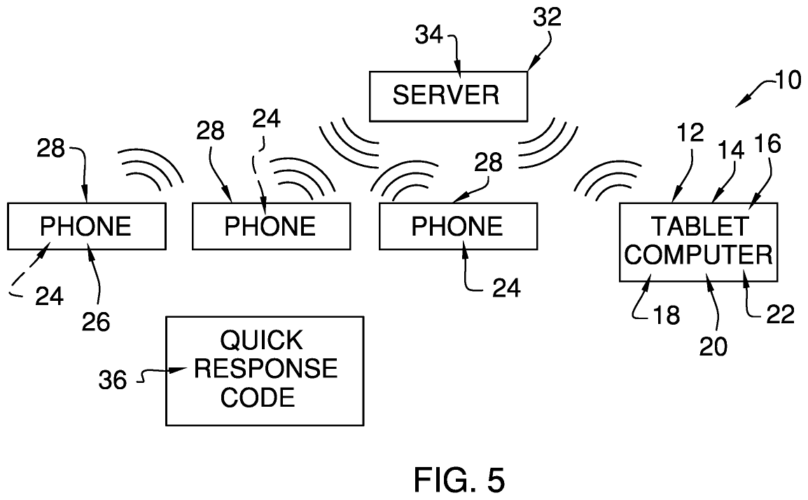

With reference now to the drawings, and in particular to FIGS. 1 through 5 thereof, a new guest book assembly embodying the principles and concepts of an embodiment of the disclosure and generally designated by the reference numeral 10 will be described.

As best illustrated in FIGS. 1 through 5, the electronic guest book assembly 10 generally comprises a host electronic device 12. The host electronic device 12 comprises a tablet computer 14, a laptop computer, a netbook computer, or the like. Host programming code 16 positioned on a computer processor 18 of the host electronic device 12 enables a display 20 of the host electronic device 12 to present to a host a list of attendees of an event, such as a funeral, memorial service, wedding, and the like. The host programming code 16 also enables the host electronic device 12 to store the list of attendees on an internal storage unit 22 of the host electronic device 12.

Attendee programming code 24, which is selectively positionable on a microprocessor 26 of an attendee electronic device 28, such as a smartphone 30, enables the attendee electronic device 28 to receive and to selectively display information and images related to the event. The attendee programming code 24 also enables the attendee electronic device 28 to signal the host electronic device 12 of an arrival of an attendee associated with the attendee electronic device 28.

The electronic guest book assembly 10 also comprises a server 32, which is configured for wireless communication with the host electronic device 12 and a plurality of attendee electronic devices 28. The attendee programming code 24 is positioned on the server 32, which is configured to selectively transmit the attendee programming code 24 to a respective attendee electronic device 28. An associated attendee is positioned to selectively install the attendee programming code 24 on the respective attendee electronic device 28. The server 32 then is positioned to relay a signal corresponding to an arrival of the associated attendee from the respective attendee electronic device 28 to the host electronic device 12. It is anticipated that the server 32 also could host an online obituary page for a decedent, and that the attendee programming code 24 would enable the associated attendee to use their respective attendee electronic device 28 to post a message of condolence to the obituary page. The server 32 also could be configured to add the list of attendees to the obituary page of the decedent.

A database 34 positioned on the server 32 comprises the information and the images related to the event. The server 32 is configured to selectively transmit the information and the images to the respective attendee electronic device 28.

A quick response code 36 is selectively positionable at an entrance to the event. The quick response code 36 is configured to be scanned by a respective attendee electronic device 28 to connect the respective attendee electronic device 28 to the server 32. An associated attendee then is positioned to selectively download and to install the attendee programming code 24 to the respective attendee electronic device 28. It is anticipated that the quick response code 36 will be unique to one or more of a respective venue, such as a funeral home, and a respective event, such as a funeral.

The electronic guest book assembly 10 also comprises a stand 38, which is configured to be positioned at the entrance to the event. The quick response code 36 is configured to be selectively mountable to the stand 38. It is anticipated, with the event being a funeral or memorial service, that the stand 38 also would be configured to display a picture of the decedent and the decedent's name.

In use, an attendee approaches the stand 38 and scans the quick response code 36 with their smartphone 30. The server 32 then sends the attendee programming code 24 to the smartphone 30, allowing it to be installed by the attendee. Upon installation of the attendee programming code 24, a signal is sent to the server 32, whereupon the server 32 sends a signal to the tablet computer 14 notifying the host of the attendee's presence at the event. The server 32 also transmits the information and the images to the attendee's smartphone 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic guest book assembly comprising:
a host electronic device;
host programming code positioned on a computer processor of the host electronic device enabling a display of the host electronic device for presenting a list of attendees of an event to a host and for storing the list of attendees on an internal storage unit of the host electronic device; and
attendee programming code selectively positionable on a microprocessor of an attendee electronic device enabling the attendee electronic device for receiving and selectively displaying information and images related to the event and for signaling the host electronic device of an arrival of an attendee associated with the attendee electronic device.

2. The electronic guest book assembly of claim 1, wherein the host electronic device comprises a tablet computer.

3. The electronic guest book assembly of claim 1, further including:
a server configured for wireless communication with the host electronic device and a plurality of attendee electronic devices, the attendee programming code being positioned on the server, wherein the server is configured for selectively transmitting the attendee programming code to a respective attendee electronic device, positioning an associated attendee for selectively installing the attendee programming code on the respective attendee electronic device, such that the server is positioned for relaying a signal corresponding to an arrival of the associated attendee from the respective attendee electronic device to the host electronic device; and
a database positioned on the server comprising the information and the images related to the event, wherein the server is configured for selectively transmitting the information and the images to the respective attendee electronic device.

4. The electronic guest book assembly of claim 3, further including a quick response code selectively positionable at an entrance to the event, wherein the quick response code is configured for scanning by a respective attendee electronic device for connecting the respective attendee electronic device to the server, enabling an associated attendee for selectively downloading and installing the attendee programming code to the respective attendee electronic device.

5. The electronic guest book assembly of claim 4, further including a stand configured for positioning at the entrance to the event, the quick response code being configured to be selectively mountable to the stand.

6. An electronic guest book system comprising:
a server configured for wireless communication;
a database positioned on the server comprising the information and the images related to and event;
a host electronic device wirelessly engaged to said server;
host programming code positioned on a computer processor of the host electronic device enabling a display of the host electronic device for presenting a list of attendees of an event to a host and for storing the list of attendees on an internal storage unit of the host electronic device;
a plurality of attendee electronic devices selectively wirelessly engageable to said server, each attendee electronic device being associated with a respective attendee of an event; and
attendee programming code positioned on the server, such that the server is positioned for selectively transmitting the attendee programming code to a respective attendee electronic device, positioning an associated attendee for selectively installing the attendee programming code on a microprocessor of the respective attendee electronic device, enabling the attendee electronic device for receiving and selectively displaying the information and the images related to the event and for signaling the server of an arrival of the associated attendee, such that the server is positioned for signaling the host electronic device of an arrival of the associated attendee.

7. The electronic guest book system of claim 6, wherein the host electronic device comprises a tablet computer.

8. The electronic guest book system of claim 6, further including a quick response code selectively positionable at an entrance to the event, such that the quick response code is positioned for scanning by a respective attendee electronic device for connecting the respective attendee electronic device to the server, enabling an associated attendee for selectively downloading and installing the attendee programming code to the respective attendee electronic device.

9. The electronic guest book system of claim 8, further including a stand configured for positioning at the entrance to the event, the quick response code being configured to be selectively mountable to the stand.

10. An electronic guest book assembly comprising:
a host electronic device, the host electronic device comprising a tablet computer;
host programming code positioned on a computer processor of the host electronic device enabling a display of the host electronic device for presenting a list of attendees of an event to a host and for storing the list of attendees on an internal storage unit of the host electronic device;
attendee programming code selectively positionable on a microprocessor of an attendee electronic device enabling the attendee electronic device for receiving and selectively displaying information and images related to the event and for signaling the host electronic device of an arrival of an attendee associated with the attendee electronic device;
a server configured for wireless communication with the host electronic device and a plurality of attendee electronic devices, the attendee programming code being positioned on the server, wherein the server is configured for selectively transmitting the attendee programming code to a respective attendee electronic device, positioning an associated attendee for selectively installing the attendee programming code on the respective attendee electronic device, such that the server is positioned for relaying a signal corresponding to an arrival of an associated attendee from the respective attendee electronic device to the host electronic device;
a database positioned on the server comprising the information and the images related to the event, wherein the server is configured for selectively transmitting the information and the images to the respective attendee electronic device;
a quick response code selectively positionable at an entrance to the event, wherein the quick response code is configured for scanning by a respective attendee electronic device for connecting the respective attendee electronic device to the server, enabling an associated attendee for selectively downloading and installing the attendee programming code to the respective attendee electronic device; and
a stand configured for positioning at the entrance to the event, the quick response code being configured to be selectively mountable to the stand.
